(19) United States
(12) Patent Application Publication
(10) Pub. No.: US 2003/0194097 A1
(43) Pub. Date: Oct. 16, 2003

(54) Motional feedback for a speaker system

(76) Inventor: Chih-Shun Ding, Orange County, CA (US)

Correspondence Address: CHIH-SHUN DING, 11655 ALLEN ST., TUSTIN, CA, 92782, US

(21) Appl. No.: 10/123,643

(22) Filed: Apr. 16, 2002

(51) Int. Cl. H04R 29/00; H04R 3/00

(52) U.S. Cl. 381/96; 381/59

(57) ABSTRACT

A bass reproduction speaker apparatus of the present invention includes: A cabinet with two openings; a speaker unit disposed at the first opening; a bass enhancement member disposed at the second opening; an amplifier for driving the speaker unit; a first detector for detecting a vibration of diaphragm of the speaker unit; a second detector for detecting a vibration of the bass enhancing member; a current sensing circuit for measuring the current through the speaker unit; and feedback circuits for feeding back the signals from the detectors and the current sensing circuit output to the amplifier.

### CROSS-REFERENCE TO RELATED APPLICATIONS

This application is entitled to the benefit of Provisional Patent Application Ser. No. 60/284031

### BACKGROUND

1. Field of Invention

The present application is related generally to the field of high fidelity speaker systems.

2. Prior Art

In recent years, bass frequency reproduction has become increasingly important in audio reproduction systems. In order to enhance sound reproduction at bass frequency, enhancement devices such as passive radiators (such as numeral 2 in FIG. 1) or bass vented pipes (such as numeral 5 in FIG. 4) is used in some speaker designs. For the sake of presentation, speakers with passive radiators will be referred to as passive radiator speakers and abbreviated as PR in the remainder of this disclosure. Speakers with bass vented pipes will be referred to vented speaker and abbreviated as VB in the remainder of the disclosure. Examples of passive radiator speakers are shown in FIGS. 1 to 3. In FIG. 1, the speaker box contains only one cavity. Two (direct) radiators are located at two openings of the cavity: one active and one passive. The active radiator (driver) 1 receives electrical energy from a power amplifier. Since the cavity is located behind the active radiator, cavity 3 will also be referred to as rear cavity. In FIG. 2, the speaker box contains two cavities: one front cavity 11 and one rear cavity 12. The active driver is located on the dividing wall of these two cavities. Again, the active driver receives electrical energy from a power amplifier. Two passive radiators are located at two openings, with one opening at each cavity. The sound is output from those two passive radiators. In FIG. 3, the speaker enclosure contains also two cavities. However, only one cavity accommodates a passive radiator. Again, an active driver is located on the dividing wall of the two cavities. Here I draw the case where the passive radiator is located at the front cavity 31. Alternatively, it can also be located at the rear cavity 32. For the sake of presentation, speakers described in FIGS. 1 to 3 are referred to as PR1, PR2, and PR3, respectively. Each of the passive radiators in FIG. 1 to 3 is mated with a cavity to form a resonator. As a result, the output is boosted at around the resonance frequency. To be consistent in this disclosure, all cavities that locate in front of (behind) the active driver or radiator are referred to as front (rear) cavities. All those drivers that receive electrical energy will be referred to as active radiator if they directly contribute to sound output, and active driver otherwise (for instance, the driver in cavity 32 of FIG. 3).

Passive radiators can be replaced with vented pipes for the purpose of bass enhancement. For instance, FIGS. 4 to 6 show the vented pipe versions of FIGS. 1 to 3. FIGS. 4 to 6 will also be referred to as VB1, VB2, and VB3, respectively. The air mass in the pipe acts as the moving mass of the passive radiator. In addition, the compliance of the air in the pipe is so large that they can be largely ignored during analysis. For this reason, vented pipe versions can be regarded as degenerated cases of passive radiator speakers. In terms of analysis, PR speakers are more complicated when writing the close form expressions. As a result, in this disclosure I will primarily focus on PR speakers, with the exception of PR2. The analysis results can be extended from PR speakers to VB speakers, or vice versa.

Both PR and VB speakers pose challenges to motional feedback, or servo, techniques because the overall system response is a complex function of the motional signals detected from the active speaker driver and the passive radiator (or the vented pipe). As a result, the motional feedback network can be too complicated if not infeasible. This problem is evident, as the currently commercially successful speakers with motional feedback are limited to sealed box configuration, which does not employ the above mentioned bass enhancement devices.

Various motional feedback techniques have been proposed in the past with only limited success in the passive radiator and vented box systems. U.S. Pat. No. 5,191,619 taught a method to use a positive feedback from passive radiator or vent pipe to control the frequency response. The issue with this method is that no close-form equation is provided, therefore it is mostly an ad hoc approach. A second disadvantage is the motional is used as positive feedback, which brings in potential stability problem.

U.S. Pat. No. 4,118,600 used a positive current feedback to create a negative output resistance and hence cancel out the voice coil DC resistance and at the same time used the back EMF signal from the voice coil as motional feedback signal. This technique can also be used for speakers with passive radiators and vented pipes. However, the disadvantage is that no other forms of motional feedback (such as accelerometer) can be used. The second disadvantage is the positive current feedback can cause instability if it is not used properly.

U.S. Pat. No. 5,588,065 proposed a motional feedback method to speakers that have a division wall inside the speaker box. This type of speaker box configuration is generally referred to as bandpass speaker as it has two resonance frequencies and these two frequencies determine the bandwidth of the sound reproduction. The motional feedbacks proposed in this patent are then used to substantially aligns a height of peaks in an output sound pressure level versus frequency response at the above-mention two resonance frequency in order to obtain a substantially flat response. No current feedback is used here. The disadvantage is that it is only applicable to bandpass speakers (such as those shown in FIGS. 3 and 6).

U.S. Pat. Nos. 5,764,781 and 6,104,817 used a sensing coil wound on the voice coil former or a piezo-electric sensor coupled thereto to derive the motional feedback signal. This signal is fed back to the power amplifier along with a current feedback. Both feedbacks are negative. The disadvantage is that the motional feedback needs to be derived from the active driver.

### SUMMARY OF THE INVENTION

It is the object of the present invention to provide motional feedbacks to a bass enhancement speaker system with passive radiators and vented pipes. The amplifier system in the speaker system employs negative motional feedback signals in the following forms:

1) the velocity or acceleration signal from the active driver.

2) The velocity or acceleration signal from the passive radiator.

3) The pressure signal from the cavity.

Single or multiple combination of motional feedbacks can be used at the same time. Since all motional feedbacks are negative, speaker systems of present invention have a very good stability characteristic. In addition, the speaker systems according to the present invention are easy to analyze, design, and manufacture.

### DESCRIPTION OF THE DRAWINGS

In the accompanying drawings:

FIG. 1 is a speaker with one cavity, one active radiator and one passive radiator.

FIG. 2 is a speaker with two cavities, one active driver, and two passive radiators.

FIG. 3 is a speaker with one cavity, one active driver, and one passive radiator.

FIG. 4 is a speaker with one cavity, one active radiator, and one vent pipe.

FIG. 5 is a speaker with two cavities, one active driver, and two vent pipes.

FIG. 6 is a speaker with one cavity, one active driver, and one vent pipe.

FIG. 7 shows the equivalent impedance network observed from the active driver of FIG. 1.

FIG. 8 is the reference model of the speaker in FIG. 1.

FIG. 9 is the equivalent control block diagram of the speaker system in FIG. 8.

FIG. 10 is an embodiment of the present invention for speaker in FIG. 1.

FIG. 11 is the equivalent control block diagram of FIG. 10.

FIG. 12 is the same as FIG. 10 except the feedback from the passive radiator is acceleration signal.

FIG. 13 is same as FIG. 12 except the polarity of the feedback signals from the active and passive radiators are the same.

FIG. 14 is an embodiment of present invention with high pass filter at the system input

FIG. 15 is an embodiment of present invention with additional high pass characteristic.

FIG. 16 is the synthesis model of PR1.

FIG. 17 is the control block diagram of FIG. 16.

FIG. 18 is an embodiment of present invention with current feedback.

FIG. 19 is the control block diagram for FIG. 18.

FIG. 20 is an embodiment of present invention with current feedback.

FIG. 21 shows a typical relative contribution of feedbacks in FIG. 20.

FIG. 22 shows a typical relative contribution of feedbacks in FIG. 20 with a slightly different type of feedback.

FIG. 23 shows the preferred embodiment with current feedback.

FIG. 24 shows the general synthesis model for FIG. 3 speaker configuration.

FIG. 25 shows an embodiment of present invention.

FIG. 26 shows how a high pass and low pass characteristic forms a bandpass characteristic.

FIG. 27 shows the equivalent impedance observed from the active driver in FIG. 5.

FIG. 28 shows the equivalent impedance observed from the active driver in FIG. 2.

FIG. 29 shows the reference model of FIG. 5.

FIG. 30 shows the general synthesis model for FIG. 5.

FIG. 31 shows an embodiment of present invention for speakers of FIG. 5.

FIG. 32 shows an embodiment of present invention for speakers of FIG. 2.

FIG. 33 shows yet an embodiment of present invention for speakers of FIG. 2.

### DESCRIPTION OF THE PREFERRED EMBODIMENT

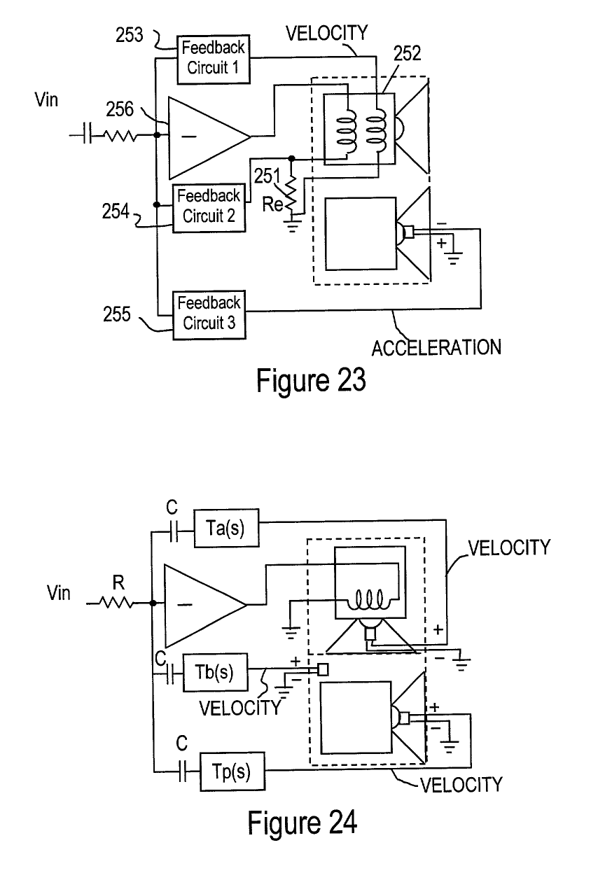

FIG. 23 shows the preferred embodiment of the present invention with the following:

1) current feedback derived from current sensing resistor 251;

2) a motional feedback from active radiator is derived from a sensing coil wound on the same former as the driving coil of the active radiator, the driving coil receive electrical energy from the amplifier, and

3) a motional feedback from the passive radiator is derived an accelerometer attached to the passive radiator.

4) The polarities of the feedback signals are referenced to the direction outward from the enclosure.

5) All of the feedbacks are negative.

6) Amplifier 256 is inverting.

One criterion to determine if a feedback is negative is as follows. If the removal of the said feedback cause the system response to increase, the feedback is negative.

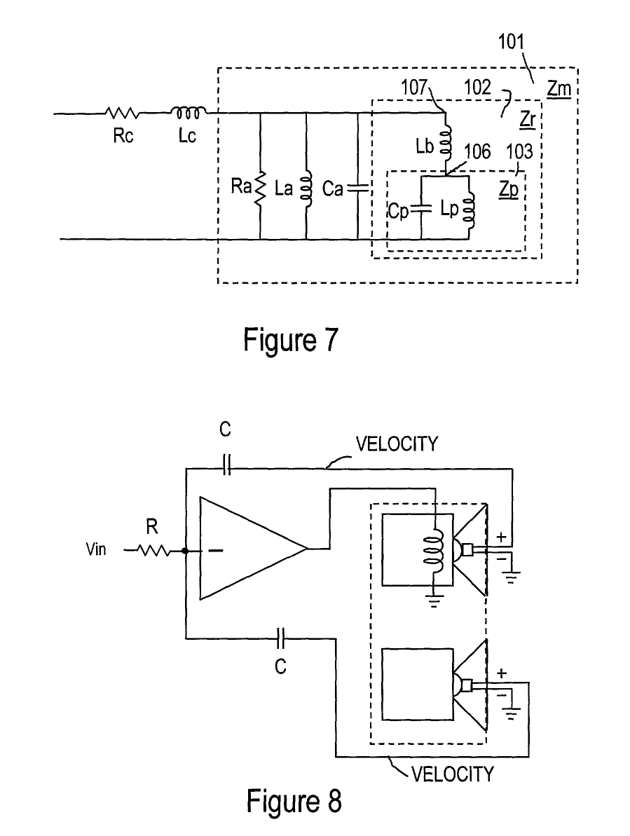

To explain how the present invention works, I will first describe some basic principles of PR1 speakers. FIG. 7 shows the equivalent impedance network observed from the active radiator in PR1 speakers. Lc and Rc are the inductance and resistance of the voice coil, respectively. La, Ra, and Ca are related to the compliance, mechanical resistance (or loss), and the moving mass of the active radiator, respectively. Lb is related to the compliance of the cavity. Lp and Cp are related to the compliance and moving mass of the passive radiator, respectively. The impedance of the network 101 of components La, Ra, Ca, Lb, Lp and Cp, denoted as Zm, is also commonly referred to as the motional impedance because, when the active radiator is blocked, this network is nonexistent (or 0). The impedance of the network 103, consisting of Lp and Cp, is denoted as Zp. The impedance of the network 102, consisting of Lp, Cp, and Lb, is denoted as Zr.

Equivalent impedance networks, such as one in FIG. 7, provide convenient models for system response analysis. This is mainly because, when the speaker is driven, voltages at various nodes in the network represent the velocities at various components in the speaker system, with some scaling factors. For instance, voltage at node 107 (106) represents the velocity of active (passive) radiator with a scaling factor. In this disclosure, V denotes the voltage drop and v denotes the velocity. The voltage at node 107 (106) is denoted as Va (Vp) while the velocity of the active radiator (passive radiator) is denoted as va (vp). va can be written as va=K1Va, where K1 is a scaling factor. In contrast, vp is written as vp=−K2Vp, where K2 is yet another positive scaling factor. The reason of the negation is because the passive radiator receives the mechanical force from the back of the active radiator.

Both active and passive radiators are direct radiators and their individual sound output is approximately proportional to both the velocities of the diaphragm and the frequency. In another words, if we want a uniform output from a direct radiator, the velocity of its diaphragm should be inversely proportional to the frequency. Interestingly, it was found that, based on ideal models, the total sound output in PR1, denoted as Eout, is proportional to s(Va−Vp), where s is the Laplace domain variable. Or it can be approximated as Eout=K3·s(Va−Vp), where K3 is a scaling factor, even though K1 and K2 can be different. In the remainder of the disclosure, I will simply write Eout=s(Va−Vp) without the loss of generality and I will use s to represent the Laplace domain variable.

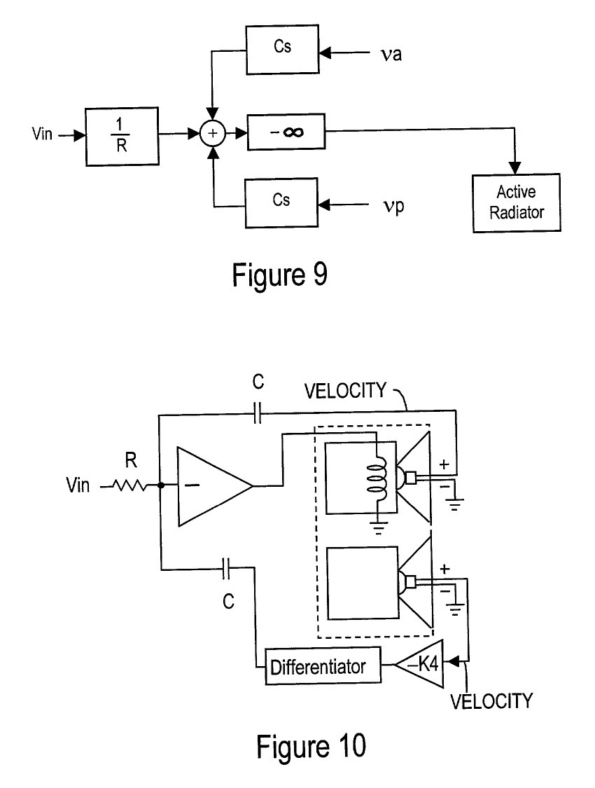

To understand how the present invention works for PR1, we shall now consider FIG. 8 with its equivalent control block diagram shown in FIG. 9. In FIG. 9 the transfer function of each circuit block is written inside its block. The objective of FIG. 8 is to make the overall system output literally uniform (or flat). Two motional feedback signals are employed: one from the active radiator and one from the passive radiator. These motional signals represent the velocities from the active radiator and the passive radiator, respectively. To further simplify the presentation, the following assumptions are made:

1) The effective moving areas of the active radiator and the passive radiator are the same.

2) The motional feedback signals from the active radiator and the passive radiator are both velocity-related and their polarities are the same (e.g. both are referred to the direction outward from the enclosure).

3) K1 and K2 are assumed to be 1. The entire analysis can be easily modified to account for general cases.

4) The gain of the power amp is infinity.

From FIG. 9, one can write:

$$\begin{matrix}\frac{Vin}{R} + sC \cdot va + sC \cdot vp = 0 & \\ \frac{Vin}{R} + sC \cdot Va - sC \cdot Vp = 0 & [ 1 ] \\ Eout = s ( Va - Vp ) = - \frac{1}{RC} Vin & [ 2 ]\end{matrix}$$

As a result, Eout is uniform.

FIG. 8 has more theoretical value than practical value, as there are excessive phase shifts at frequency close to DC which makes closed-loop compensation more difficult. In addition, uniform output is not what we really need in practice. What we need is a frequency response that is flat down to a cut-off frequency and then gradually attenuates in order to limit the excursion on active radiator. However, as will be demonstrated next, FIG. 8 calculates the frequency response of Va that produces a uniform sound output. This result will serve as the reference for our synthesis process on all PR1 systems as described later.

Before proceeding further, we first solve Va for Equation [2]. Vp can be written as Vp=T(s)Va. The steps to arrive at T(s) is as follows:

$$\begin{matrix}Zp = \frac{sLp \cdot \frac{1}{sCp}}{sLp + \frac{1}{sCp}} = \frac{sLp}{{s}^{2} LpCp + 1} = \frac{sLp}{D ( s )} \\ Zr = sLb + Zp = \frac{s ( {s}^{2} LbLpCp + Lb + Lp )}{D ( s )} = \frac{sN ( s )}{D ( s )}\end{matrix}$$

where D(s)=s²LpCp+1 and N(s)=s2LbLpCp+Lb+Lp. And finally,

$$T ( s ) = \frac{Zp}{Zr} = \frac{Lp}{N ( s )}$$

Equation [2] will be written as:

$$\begin{matrix}sVa ( 1 - T ( s ) ) = sVa ( \frac{{s}^{2} LbLpCp + Lb}{N ( s )} ) = - \frac{1}{RC} Vin & \\ Va = - \frac{1}{sRC} ( \frac{N ( s )}{{s}^{2} LbLpCp + Lb} ) Vin & [ 3 ]\end{matrix}$$

I will denote Va in Equation [3] as Va(uniform) to emphasize the fact that it produces uniform outputs:

$$\begin{matrix}Va ( uniform ) = - \frac{1}{sRC} ( \frac{N ( s )}{{s}^{2} LbLpCp + Lb} ) Vin \\ or & [ 4 ] \\ \frac{Va ( uniform )}{Vin} = - \frac{1}{sRC} ( \frac{N ( s )}{{s}^{2} LbLpCp + Lb} ) & [ 5 ]\end{matrix}$$

Another interesting aspect relevant to the present invention is the polarity of the feedbacks from the active driver and passive radiator of the system in FIG. 8. At high frequency, the feedback from the passive radiator can be ignored. That means the feedback from the active driver is decisively negative. In Equation [2], the sign of Vp and Va are opposite. That concludes the feedback from the passive radiator is positive.

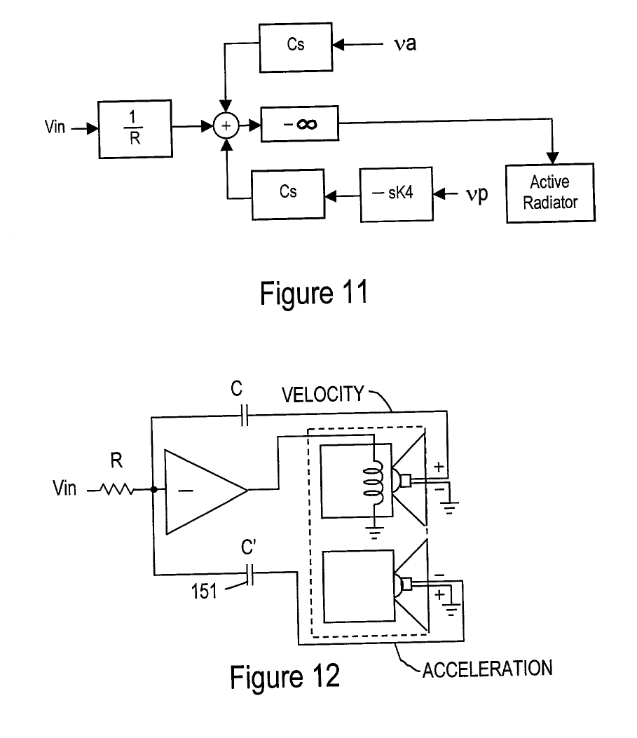

One embodiment of the present invention is shown in FIG. 10 with its control block diagram shown in FIG. 11. The speaker enclosure remains the same as that in FIG. 8. Only the feedback circuitry is modified: the feedback from the passive radiator is now negated. In addition, the feedback from the passive radiator is now multiplied by −K4 and an additional +6 db/oct characteristic (in the Laplace domain, it is represented as s). That is, vp is now multiplied by −sK4 before entering the feedback network. That means the feedbacks from active driver and passive radiator are now both negative.

The system equation is now:

$$\begin{matrix}\begin{matrix}\frac{Vin}{R} + Cs \cdot va + Cs \cdot ( - sK4 ) vp = 0 \\ \frac{Vin}{R} + Cs \cdot Va + Cs \cdot ( sK4 ) Vp = 0 ,\end{matrix} \\ or \\ sVa ( 1 + sK4T ( s ) ) = - \frac{1}{RC} Vin \\ □\end{matrix}$$

Therefore Va is solved as

$$\begin{matrix}Va = - \frac{1}{sRc} ( \frac{N ( s )}{{s}^{2} LbLpCp + sK4Lp + Lb + Lp} ) Vin \\ Or & [ 6 ] \\ Va = Va ( uniform ) \cdot \frac{{s}^{2} LbLpCp + Lb}{{s}^{2} LbLpCp + sK4Lp + Lb + Lp} & [ 7 ]\end{matrix}$$

Clearly, the new frequency response is second-order high pass (two poles) with two zeros. The zeros coincide with the resonance frequency of the passive radiator itself. This is also commonly referred to as passive radiator “notch”. It is not introduced by the motional feedback. Furthermore, one can lower those zeros by lowering the resonance frequency of the passive radiator. In the remainder of this disclosure, I will ignore the zeros without loss of generality. That is, the above equation can be rewritten as:

$$Va = Va ( uniform ) \cdot \frac{{s}^{2} LbLpCp}{{s}^{2} LbLpCp + sK4Lp + Lb + Lp} \qquad [ 8 ]$$

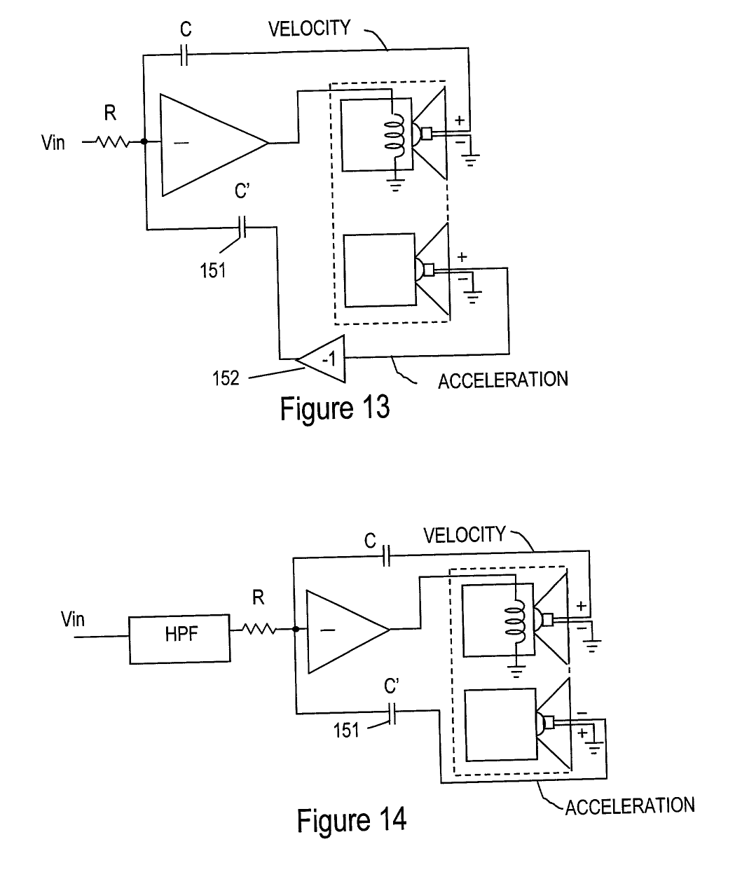

This result is surprising. By inverting the feedback from the passive radiator, we get a high pass characteristic with Q value determined by K4. One can make K4 adjustable. The result is useful because in the listening room, the room enhancement effect at low frequency may change the perceived Q value. In addition, the perceived Q value may change from one listening room to another. As a result, the adjustable Q value is a useful feature. Lastly, if the motional signal from the passive radiator is derived from an accelerometer, the acceleration signal provides the required “s” in the term “−sK4”. This can further simplify the feedback network as shown in FIG. 12. Please also note that in FIG. 12, the polarity of the sensor is reversed to remove the inverting amplifier on the feedback path. Also the scaling factor K4 is now implemented in the feedback capacitance 151 (by changing the capacitance value). FIG. 13 shows an alternative embodiment where both feedbacks from active radiator and passive radiator are referenced to the same direction (such as outward from enclosure). In this case, we need the inverter 153.

The cut-off frequency of Equation [6] coincides with the resonance frequency formed by the rear cavity and passive radiator. However, one can alter it by replacing sK4 with something else. For instance, replacing sK4 with s²K5+sK4, where K5 is a positive value, will move down the cut-off frequency; replacing sK4 with sK4+K5 will move up the cut-off frequency. The entire technique is so flexible and systematic that one can not only control the cut-off frequency, the Q value, but also choose where the sensors for motional feedbacks are placed, as will be demonstrated later, and whether more than one motional feedback signals should be used. More importantly, the result can be expressed in closed forms and therefore enables us to adopt a synthesis approach.

In terms of the frequency response characteristic, a 2^{nd} order high pass characteristic is implemented in the discussion so far for the reason of minimizing the complexity of the feedback networks. However, that is not the limitation of the present invention. As a matter of fact, a conventional PR1 exhibits a 4^{th} order high pass characteristic. In terms of excursion requirement for the active radiator, a high pass characteristic of at least 4^{th} order is more desirable. To incorporate that, we have the following alternatives:

1) Implement the additional orders of high pass characteristic in an auxiliary filter place at Vin as shown in FIG. 14.

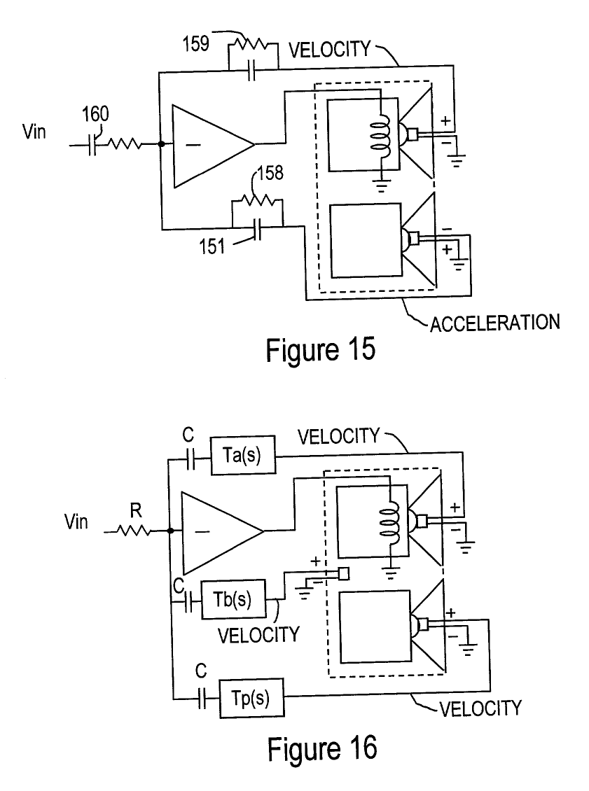

2) Implement the additional orders of high pass characteristic in the feedback networks, such as the one shown in FIG. 15. The additional components 158, 159, and 160 implement the additional high pass characteristic.

3) All of above.

To summarize the discussion so far, the design process involves two steps:

1) Build a reference model (such as the one in FIG. 8) and derive the close form expression for Va(uniform).

2) Build a synthesis model and synthesize the feedback system such that the new Va is proportional to Va(uniform) times a desired frequency characteristic. If necessary, one can also put an equalizer or filter in front of the system.

Before getting into details of the synthesis process, I will briefly discuss how the motional signal can be derived. The first category of motional signal is velocity-based; one example is sensing coil. In particular, when the sensing coil is used on the active radiator or driver, the sensing coil can be wound on the same former as the driving coil, which receives the electrical energy. This ensures the best coupling. The second category is acceleration-based; one example is accelerometer. The third category is pressure-based; one example is piezo-film. The pressure-based motional signal is best suited for sensing the pressure in the cavity while velocity-based and acceleration-based motional signals are best suited for sensing movement on the active and passive radiators. Although, pressure itself is displacement-related, the output from piezo-film is most likely to be velocity-related due to its required amplification circuitry. Let Pb denote the output from the pressure sensor. In this disclosure, I assume that the output of pressure sensor is a velocity signal, in this case Pb=−K6Vb, where Vb is the voltage drop across Lb in FIG. 7 and K6 is a scaling factor. Again the negation is because the pressure comes from the back of the active radiator diaphragm. The relation between Vb and Va is:

$$Vb + ( 1 - T ( s ) ) Va = \frac{{s}^{2} LbLpCP + Lb}{N ( s )} Va$$

In addition, I will also use vb in place of Pb for notation to signify cases where the pressure sensor outputs a velocity signal in order to be consistent with other notations. On the other hand, if a pressure sensor does pick up pressure-related signal, Pb should be written as Pb=−(K6Vb)/s and one should repeat the same analysis described later to obtain new feedback networks.

All the above-mentioned types of motional signals are largely interchangeable, provided that the feedback networks are modified accordingly. For instance, if one uses an acceleration-based signal in place of a velocity-based signal, then one needs to add an integrator between the sensing signal and the feedback network, or multiply the feedback network impedance by 1/s in Laplace domain. Some motional signals may even pick up unwanted signal components, therefore may need further modification on the networks. For instance, the sensing coil on the active driver will pick up the mutual inductance between the driving coil and the sensing coil, which causes a electrical resonance peak. To suppress the Q value of this resonance, one can use current feedback as described later.

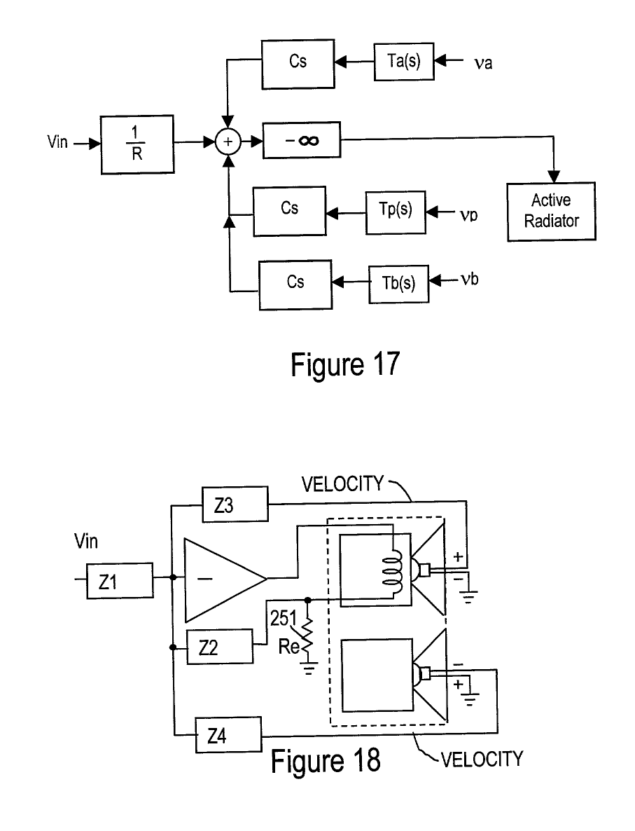

So far, I have indicated that there are at least 3 locations to place sensors: one on the active radiator, one on the passive radiator, and one in the cavity. Next I will describe a generalized synthesis model based on these three motional signals as shown in FIG. 16. To simplify the discussion, the sensors in this synthesis model are all velocity sensors. I assume that the pressure sensor in the cavity actually outputs a velocity signal. At the first glance, this may not make sense because there is no velocity in the cavity. However, I refer to it as velocity signal because the signal output is equivalent to the voltage drop on Lb of FIG. 7. To be consistent in terminology, I refer to it as velocity signal. Following the convention mentioned before, sensing signals from the sensors are denoted as follows: va for active radiator, vb for cavity, and vp for passive radiator. Furthermore, I assume that all feedback networks are through capacitors with value C. In this way, we will be able compare among different implementations. Between the sensor outputs and the feedback capacitors, circuit blocks are inserted to implement the required feedback transfer functions. Another important issue is the determination of polarities of all three motional signals. Here I assume both motional signals from the active and passive radiator are referenced to the direction outward from the enclosure. The motional signal from the cavity is referenced to increasing pressure, and hence it has an opposite polarity from the sensing signal from the active radiator, because when active radiator moves outward, the pressure in the cavity decreases. The transfer functions of these blocks are Ta(s), Tb(s), and Tp(s) for active radiator, cavity, and passive radiator, respectively. The control block diagram is shown in FIG. 17. The closed loop equation is written as:

$$CsTa ( s ) va + CsTb ( s ) vb + CsTp ( s ) vp + \frac{1}{R} Vin = 0 \qquad [ 9 ]$$

The target characteristic is the one shown in Equation [8]. Furthermore, I assume K1, K2, and K6 are all 1. The derivation can be easily generalized to other K1, K2, and K6 values. Equation [9] can be written as:

$$CsTa ( s ) Va - CsTb ( s ) Vb - CsTp ( s ) Vp + \frac{1}{R} Vin = 0$$

$$or$$

$$Cs \{ Ta ( s ) Va - Tb ( s ) \frac{{s}^{2} LbLpCp + Lb}{N ( s )} Va - Tp ( s ) \frac{Lp}{N ( s )} Va \} + \frac{1}{R} Vin = 0$$

To simplify the discussion, the following approximation is made:

s²LbLpCp+Lb≈s²LbLpCp [10]

Then the solution can be expressed as:

{Ta(s)(s2LbLpCp+Lp+Lb)−Tb(s)·s²LbLpCp−Tp(s)Lp}=s²LbLpCp+sK4Lp+Lb+Lp

In the following, possible solutions to the above equation are discussed:

Case 1.1: Use motional feedback from active and passive radiators. Ta(s)=1 and Tp(s)=K4s.

Case 1.2: Use motional feedback from active radiator only. Ta(s)=(s²LbLpCp+sK4Lp+Lp+Lb)/N(s). The Q value of N(s) is too high. Therefore it is very difficult to implement this case in practice.

Case 1.3: Use motional feedback from the cavity only. Tb(s)=−(s²LbLpCp+sK4Lp+Lp+Lb)/(s²LbLpCp). This is under the approximation of Equation [10]. Without this approximation, Tb(s)=−(s²LbLpCp+sK4Lp+Lp+Lb)/(s²LbLpCp+Lb). In this case, the Q value of the poles in Tb(s) can be too high to be practically implemented as such. However, since the resonance frequency of the passive radiator is in general much lower than that of the resonator, one can reasonably adopt the approximation of Equation [10].

Case 1.4: Use motional feedback from the passive radiator only. Tp(s)=−(s²LbLpCp+sK4Lp+Lp+Lb)/(Lp).

Case 1.5: Use motional feedback from the active radiator and cavity. Ta(s)=1, Tb(s)=−(sK4Lp)/(s²LbLpCp)=−K4/(sLbCp). Again this is assuming the approximation of Equation [10].

Case 1.6: Use motional feedback from cavity and passive radiator. One solution is Tb(s)=−(s²LbLpCp)/(s²LbLpCp)=−1 and Tp(s)=−(sK4Lp+Lp+Lb)/Lp.

In all cases, the signs of Tb(s) and Tp(s) are negative whereas the sign of Ta(s) is positive, which means all of them are negative feedbacks.

Which configuration is better? The answer depends on execution and application. Several factors need to be considered such as resonance in the sensor and the speaker component, the open loop of the amplifier, standing wave in the enclosure . . . etc. Based on the above analysis, one can see if the feedback is only from active radiator, it will be more difficult to implement a desirable frequency response. In this case, U.S. Pat. No. 6,104,817 taught a method to use current feedback to supplement the motional feedback to achieve a desirable frequency response. On the other hand, if the motional feedback from the active radiator is used with feedback from either the cavity or the passive radiator, one will be able to easily achieve the desirable response. Lastly, if the feedback either from the cavity or the passive radiator is use alone, one may need to use integrator and differentiator to implement the required feedback transfer function. In addition, the feedback networks can be modified to improve high frequency stability.

Yet another issue that has often been overlooked is the feedback stability at very low frequency range. For cases where the motional signal from the active radiator is based on velocity (such as sensing coil), one can use current feedback to enhance the feedback stability. For cases where the motional signal from the active radiator is based on acceleration, a modification to the feedback network may be required. For instance, in paper titled “Design consideration for an accelerometer-based Dynamic Loudspeaker Motional feedback System” by David Hall, presented at 87^{th} AES convention, New York, 10/18-21, Reprint 2863. It is stated “The phase boost is achieved by adding an integrator that functions between 3 and 15 hz.”, at the end of 2^{nd} paragraph of column 7. This “phase boost” is to improve the phase margin of the feedback loop. A more systematic analysis method will be described later. Again, current feedback can be also used here. In this disclosure, case 1.1 is considered as the preferred embodiment.

The techniques described above can be similarly applied to VB1 speakers. The analysis shown so far still applies (by taking the limiting case of setting Lp to infinity). Next I would like to consider the case where current feedback is also incorporated. Please note that there are existing commercially successful speakers with motional feedback that does not employ current feedback. The purpose of current feedback is to provide additional stability as described below.

The first advantage of incorporating current feedback is that it enhances DC stability. Note that the system in FIG. 8 does not show the DC-feedback circuitry, which is inside the power amplifier. Current feedback can provide a DC feedback path. Second, when one use sensing coil to derive the motional signal from active radiator, the sensing coil picks up both the velocity signal of the cone and the mutual inductance between the sensing coil and driving coil. Motional feedback without current feedback could creates a peak at the higher end of the reproduction frequency because of this inductance. Current feedback helps reduce this peak. Third, the current feedback can improve overload characteristic. That is, it can help to damp out the ringing or oscillation caused by overload. This applies to all types of motional feedback signals.

While current feedback has all the above-mentioned advantages, it may change the final system response. One can follow the steps described in U.S. Pat. No. 6,104,817 to obtain the close form expression for the overall system response. The analysis is outlined as follows.

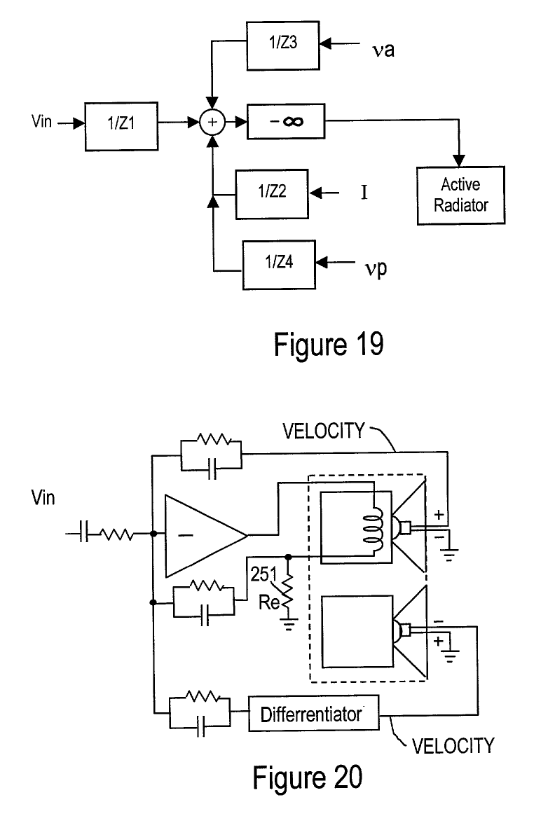

FIG. 18 shows the circuit block diagram of a system of FIG. 12 incorporating a current feedback. All feedback circuitry is now generalized as blocks of feedback networks. Re is the current sensing resistor. I assume Re=1 ohm to simplify analysis. Again, two velocity signals are employed: one from the active radiator and one from the passive radiator. FIG. 19 shows the control block diagram of FIG. 18. The closed loop equation can be written as:

$$\frac{1}{Z1} Vin + \frac{1}{Z2} I + \frac{1}{Z3} va - \frac{1}{Z4} vp = 0$$

All the assumptions that I have made to simplify analysis (such as va=Va, vp=−Vp) still hold. Therefore we can write:

$$\frac{1}{Z1} Vin + \frac{1}{Z2} I + \frac{1}{Z3} Va + \frac{1}{Z4} Vp = 0 \\ or \\ ( 1 + T ( s ) \frac{Z3}{Z4} ) Va + \frac{Z3}{Z2} I = - \frac{Z3}{Z1} Vin \qquad [ 11 ]$$

We can rewrite Equation [11] as:

Va+T(s)F(s)Va+Z(s)I=−G(s)Vin [12]

where F(s)=Z3/Z4, Z(s)=Z3/Z2, and G(s)=Z3/Z1.

In Equation [12], the first term Va is based on the motional signal from the active driver while the Va in the second term T(s)F(s)Va is based on the motional signal from the passive radiator. Each of these signals may deviate from the ideal characteristic in its own way. Therefore these two Va's may not be same. Therefore I rewrite the first term as Va′ to differentiate it from the Va in the second term:

Va′+T(s)F(s)Va+Z(s)I=−G(s)Vin [13]

In terms of analysis, both Va′ and Va should include all unwanted components that they may pick up. In the following, I will use sensing coil on active driver to explain how this is done. When the sensing coil is wound on the driving coil of the active driver, it picks up an unwanted signal—the mutual inductance between the sensing and driving coils. Modeling this can be done as:

Va′=Zm·I+Le·I [14]

where Le is the voice inductance. However, Va, which is from passive radiator, which will be assumed to be ideal in this discussion. So we have

Va=Zm·I

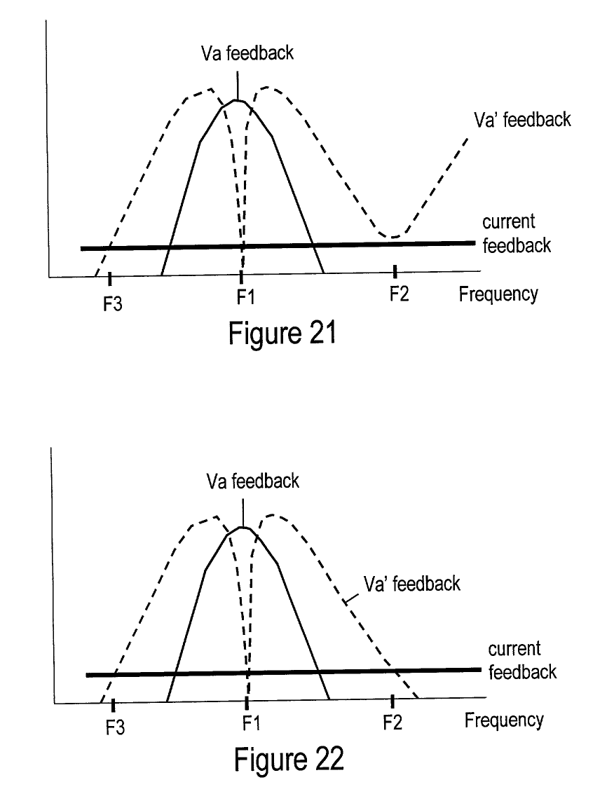

Equation [13] is then solved for I. Then I times Zm gives Va, which is then divided by the ratio given in Equation [5] to give the final response. The above illustration is based on the feedbacks from active and passive radiators. It can be easily modified to apply to cases 1.1-1.6. To summarize, one purpose of current feedback is to improve the stability of the feedback system. The above outlines the process of how to analyze the final frequency response when current feedback is incorporated. Z(s) can be as simple as resistive or as complex as of a network. To lend some sight to current feedback combined with motional feedback, we will look at one embodiment of present invention shown in FIG. 20, from which we will compare the relative contribution of feedback signal from I, Va′, and Va. FIG. 21 shows typical relative contributions of those feedbacks with current feedback as the base line. Here Va′ feedback, which is from the active radiator, is assumed to be from sensing coil, therefore contains the mutual inductance between driving and sensing coils, which cause the rise on the right-hand side. The Va feedback refers to the feedback from the passive radiator. The level of the current feedback is set such that it controls the Q value at F2. In this case, it creates a 2^{nd} low pass characteristic at F2. It also creates a minor pole approximately at the intersection of current feedback and Va′ feedback curves, F3. On the other hand, FIG. 22 shows the same circuit with the difference that Va′ is now derived from acceleration-based signal and then converted to velocity signal. Note the absence of rise on the right hand side of Va′ feedback. The current feedback creates two poles, which are approximately located at the intersection of Va′ feedback and current feedback curves, at F2 and F3. Please note that FIG. 21 and 22 are only approximation. Their purpose is to give an intuitive explanation of how current feedback change the frequency response.

Equation [13] also provides an effective method to analyze the feedback stability at lower end frequency range. The method first converts all the left-hand side terms to functions of I and then sums into one term. The coefficient of this term presents a network. Any high Q value in this network indicates potential feedback instability. Other method such as rate of closure is also helpful.

The PR3 configuration will be considered next. The reference model is similar to FIG. 8 except that there is no motional signal from the active driver. The close loop equation is

$$sCvp + \frac{1}{R} Vin = 0$$

$$sCVp + \frac{1}{R} Vin = 0$$

Note that there is no inversion from vp to Vp because the passive radiator is located in the front cavity. Therefore:

$$Va ( uniform ) = - \frac{1}{sRC} \frac{( {s}^{2} LbLpCb + Lb + Lp )}{Lp} Vin$$

VB3 and PR3 are generally referred to as band-pass speakers for a reason. For the frequency above resonance, the excursive on the passive radiator diminishes very fast compared to that of active driver. In fact, the rate is −12 db/oct. That means the active radiator needs to work very hard to get meaningful output from the passive radiator. Therefore attenuation is needed. Exactly at which frequency one should begin attenuation is a trade-off between efficiency and output bandwidth. On the other hand, at the frequency below the resonance, the excursion of passive radiator is approximately the same as the active driver. Therefore no significant boost in the output either. Consider both factors, one can conclude it is best to use a band-pass characteristic. The lower cut-off frequency is around the resonance while the higher cut-off frequency is some frequency higher. The present invention is different from U.S. Pat. No. 5,588,065 in that the lower and higher cut-off frequencies of the band-pass characteristic do not need to coincide with the peaks of the impedance curve of the active driver.

The synthesis model is similar to that in FIG. 12, as shown in FIG. 24. There are 3 locations from which motional signal can be derived: active driver, front cavity, and passive radiator which are denoted as va, vb, vp. The motional signal from the rear cavity is equivalent to the motional signal from the active driver and is therefore omitted from the analysis. The close loop equation is same as Equation [9] as:

$$CsTa ( s ) va + CsTb ( s ) vb + CsTp ( s ) vp + \frac{1}{R} Vin = 0$$

$$CsTa ( s ) Va + CsTb ( s ) Vb + CsTp ( s ) Vp + \frac{1}{R} Vin = 0$$

$$Cs \{ Ta ( s ) + Tb ( s ) \frac{{s}^{2} LbLpCp + Lb}{N ( s )} + Tp ( s ) \frac{Lp}{N ( s )} \} Va + \frac{1}{R} Vin = 0$$

After adopting approximation of Equation [10], the new system function becomes:

$$Cs \{ Ta ( s ) + Tb ( s ) \frac{{s}^{2} LbLpCp}{N ( s )} + Tp ( s ) \frac{Lp}{N ( s )} \} Va + \frac{1}{R} Vin = 0$$

Synthesis examples are given as follows. case 3.1. Ta=1, and Tp=sK4. It would be interesting to compare this same case in PR1 and PR3. One immediate difference from the above equations is that there is no inversion on Tp(s) for PR3. The resulting Va is

$$Va = Va ( uniform ) \cdot ( \frac{Lp}{{s}^{2} LbLpCp + sK4Lp + Lb + Lp} ) \qquad [ 15 ]$$

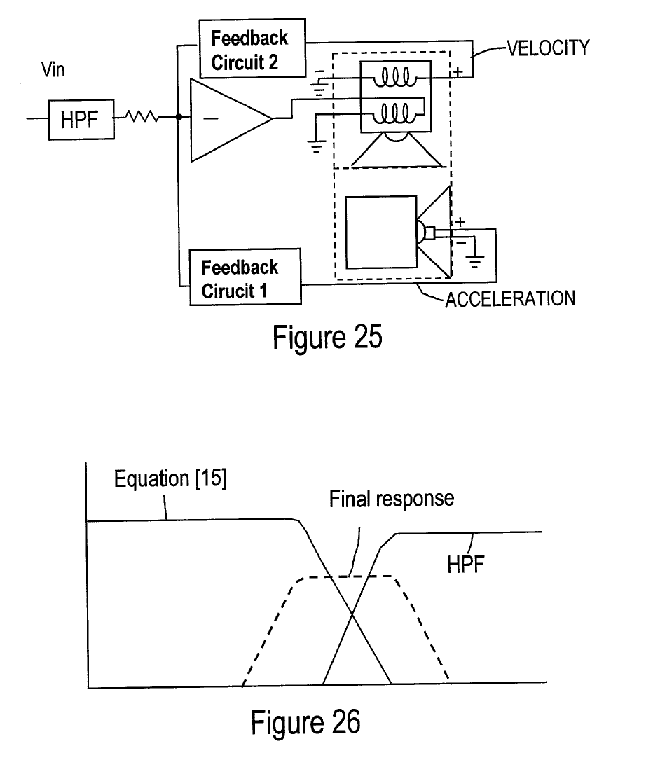

It is also interesting to note that the new characteristic is a 2^{nd} order low-pass instead of a high-pass in PR1. To complete a band-pass characteristic, one can add an auxiliary filter at the system input. FIG. 25 shows an embodiment based on this configuration. FIG. 26 shows how the HPF and Equation [15] together form a bandpass characteristic. This result also illustrates another difference between the present invention and U.S. Pat. No. 5,588,065.

Case 3.2: The motional signal is from the passive radiator only. To get the same response as in Equation [15], we have Tp(s)=(s²LbLpCp+sK4Lp+Lb+Lp)/Lp.

Case 3.3: the motional signals are from the active driver and the front cavity. Ta(s)=1, and Tb(s)=K4/LbCp. Other cases can be similarly derived. Note that the sign of Tp(s) and Tb(s) are all positive. This is mainly because the passive radiator is located in the front cavity of the active driver. If the passive radiator is located at the rear cavity and vb is derived from the rear cavity, then the signs of Tp(s) and Tb(s) will be negative. Either case, the motional feedbacks are negative.

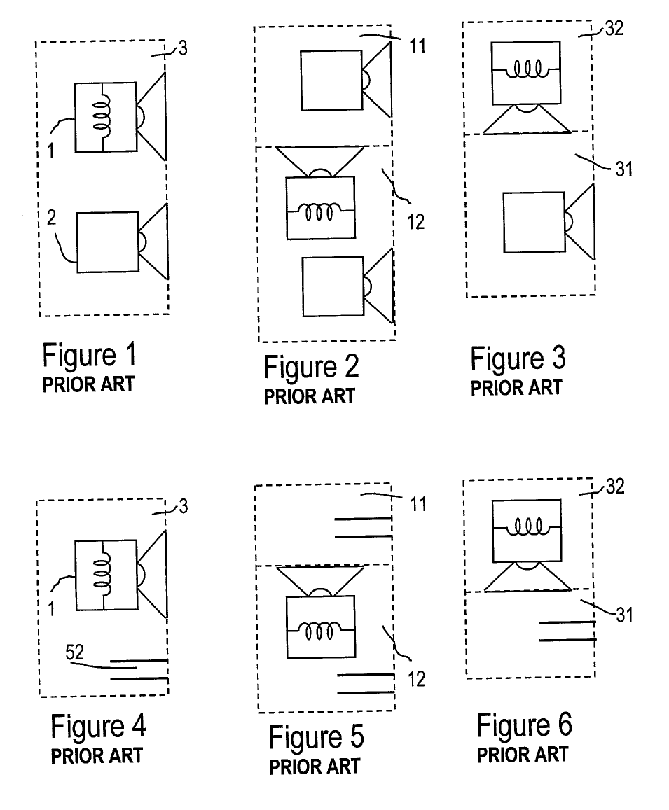

Next I will explain the case for VB2 (FIG. 5), instead of PR2 (FIG. 2). The reason is that the Equation for PR2 is more complicated, which can make the explanation more difficult. Whenever possible, I will list the expression for PR2 for reference purpose.

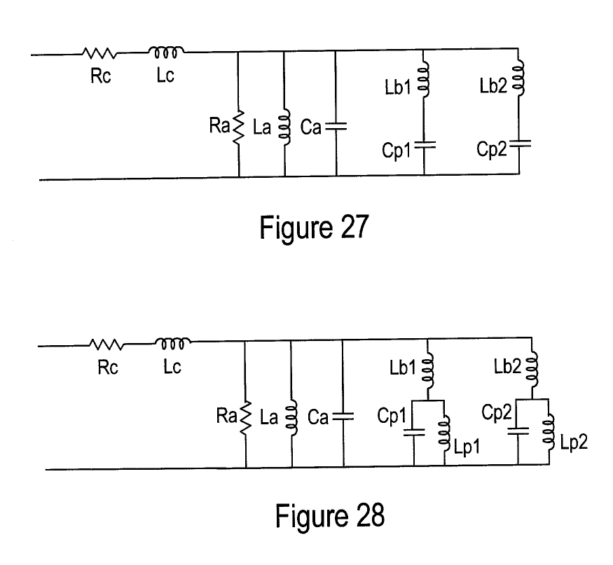

FIG. 27 shows the equivalent impedance network observed from the active driver for VB2. Lb1 (Lb2) and Cp1 (Cp2) are for the front (rear) cavity. The former is related to cavity volume and the latter is related to the mass in the vent. For PR2, the equivalent impedance network is shown in FIG. 28. First we need to derive the reference system. I will assume the front and rear vents contribute equally to the acoustic output, that is:

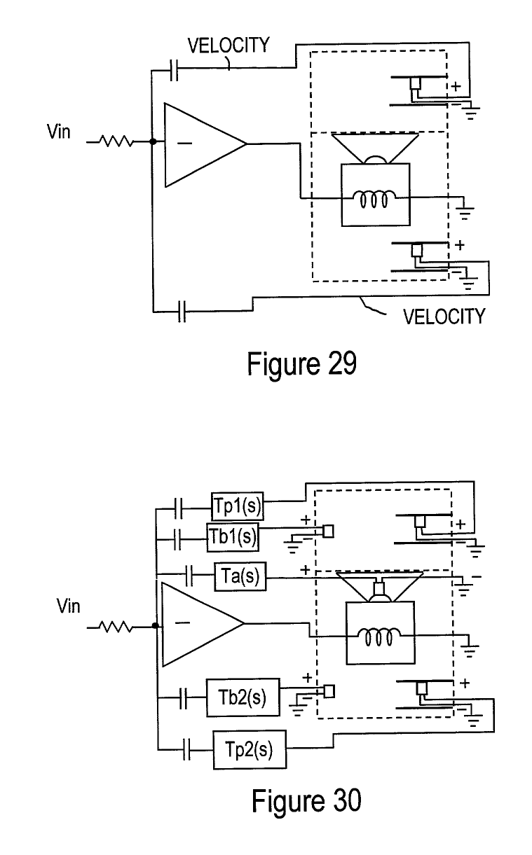

Eout=s(vp1+vp2)

where vp1 and vp2 are the velocity signals from the front vent and rear vent, respectively. Both are reference with the same direction (for instance, outward from the box). Therefore, we can set up the reference system as the on in FIG. 29. The closed loop equation is:

$$Csvp1 + Csvp2 + \frac{1}{R} Vin = 0$$

Vp1(Vp2) is the voltage drop across Cp1(Cp2). Therefore, vp1=K11Vp1 and vp2=−K12Vp2. The negative sign is because the rear passive radiator receives the energy from the back of active driver. If we assume K11=K12=−1, then the above equation can be written as:

$$CsVp1 - CsVp2 + \frac{1}{R} Vin = 0$$

Again, Va denotes the voltage drop across the motional impedance network. The relations between Vp1, Vp2 and Va are:

$$\begin{matrix}Vp1 = \frac{1}{{s}^{2} Lb1Cp1 + 1} Va \\ Vp2 = \frac{1}{{s}^{2} Lb2Cp2 + 1} Va\end{matrix}$$

The resulting Va can be written as

$$\frac{{s}^{2} ( Lb2Cp2 - Lb1Cp1 )}{N1 ( s ) N2 ( s )} Va = - \frac{1}{sRC} Vin$$

where N1(s)=s²Lb1Cp1+1 and N2(s)=s² Lb2Cp2+1. So Va(uniform) is written as:

$$Va ( uniform ) = - \frac{1}{sRC} \frac{N1 ( s ) N2 ( s )}{{s}^{2} ( Lb2Cp2 - Lb1Cp1 )} Vin$$

Next is the synthesis step as shown in FIG. 30. The objective is to create a characteristic of 2^{nd} order high pass and 2^{nd} order low pass. All feedbacks are velocity-based. Again va, vb1, vb2, vp1, and vp2 are velocity feedback signals for active driver, front cavity, rear cavity, front vent, and rear vent, respectively. For the new system, we can write the equation as:

$$sCTa ( s ) va + sCTp1 ( s ) vp1 + sCTb1 ( s ) vb1 + sCTp2 ( s ) vp2 + sCTb2 ( s ) vb2 + \frac{1}{R} Vin = 0$$

$$sCTa ( s ) Va + sCTp1 ( s ) Vp1 + sCTb1 ( s ) Vp1 + sCTb2 ( s ) Vb2 - sCTp2 ( s ) Vb2 + \frac{1}{R} Vin = 0$$

$$\{ Ta ( s ) + \frac{Tp1 ( s ) + {s}^{2} Lb1Cp1 \cdot Tb1 ( s )}{{s}^{2} Lb1Cp1 + 1} - \frac{Tp2 ( s ) + {s}^{2} Lb2Cp2 \cdot Tb2 ( s )}{{s}^{2} Lb2Cp2 + 1} \} Va = - \frac{1}{sRC} Vin$$

One set of solution is Ta(s)=1. Tp1(s)=sK5+s²K4K5, and Tp2(s)=−K4s, if Lb2Cp2<Lb1Cp1, or Ta(s)=1. Tp1(s)=sK5, and Tp2(s)=−(K4s+s²K5K4) otherwise. The resulting frequency response of Va is approximately:

$$Va \approx Va ( uniform ) \frac{{s}^{2} ( Lb2Cp2 - Lb1Cp1 )}{( {s}^{2} Lb2Cp2 + sK5 + 1 ) ( {s}^{2} Lb1Cp1 + sK4 + 1 )} \qquad [ 16 ]$$

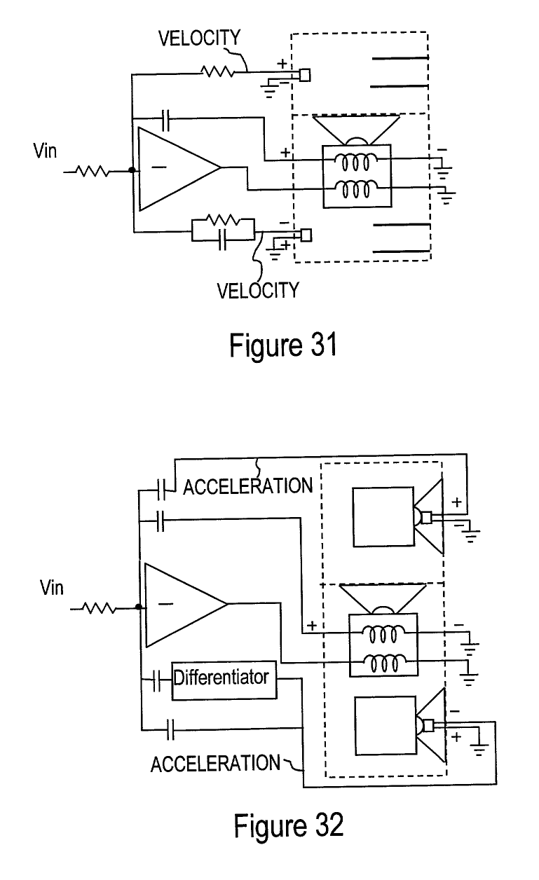

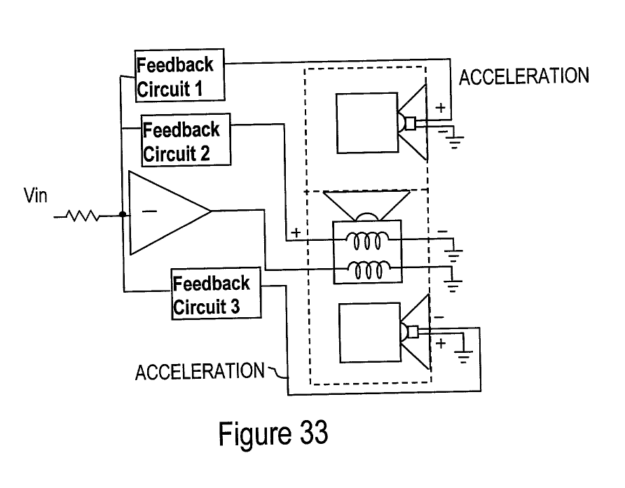

The reason I use the above equation even though it is only an approximation is that a purely negative feedback system is preferred for stability reason. For VB2, the feedback from vb1 and vb2 may be better than vp1 and vp2. In this case, Ta(s)=1. Tb1(s)=K5/(sLb1Cp1). Tb2(s)=−[K4/(sLb2Cp2)+(K4K5)/(Lb2Cp2)], when Lb2Cp2>Lb1Cp1. FIG. 31 shows the embodiment. FIG. 32 and 33 show the PR2 configuration and uses feedbacks from passive radiators and the active driver.

To get exact solution in Equation [16] (that is, replacing approximation sign with equal sign), the solution would have been Ta(s)=1,Tp1(s)=sK5+K4K5/(Lb2Cp2−Lb1Cp1), and Tp2(s)=−{sK4−K4K5/(Lb2Cp2−Lb2Cp2)}. That means one of Tp1(s) and Tp2(s) will have a combination of positive and negative feedback. In this case, current feedback may be needed to stabilize the feedback system.

Lastly, all the current feedbacks mentioned in this disclosure can be replaced with feedback from the output of the power amplifier. The reason is that this feedback is equivalent to current feedback times the equivalent impedance of the active driver (radiator). In some application, this conversion does not affect the overall frequency response by much. However, it does increase the fluctuation of frequency response due to the change in the voice coil resistance that is caused by factors such as voice coil heat-up.

Those skilled in the art will appreciate that stated in its most general terms, the invention presents a way of improving bass response. To accomplish this, single or multiple motional feedbacks are used. Current feedback is used to improve stability. In addition, various other modifications are apparent to and can be readily made by those skilled in the art without departing from the scope and spirit of this invention.

What is claimed is:

1. A bass reproduction speaker apparatus, comprising:
a cabinet with two openings;
a speaker unit disposed at the first opening of the cabinet, having a diaphragm for emitting sound waves;
an amplifying means for driving the speaker unit;
a bass enhancing member that enhances bass range sound waves, said bass enhancing member is disposed at the second opening of the cabinet;
a vibration detecting means, included in the bass enhancing member, for detecting vibration of the bass enhancing member and for releasing detecting signals; and
a feedback means for negatively feeding back the detecting signals to the amplifying means.

2. The bass reproduction speaker apparatus according to claim 2, further comprising a second vibration detecting means, included in the said speaker unit, for detecting vibration of the speaker unit and for releasing second detecting signals; and a second feedback means for negatively feeding back the second detecting signals to the amplifying means.

3. The bass reproduction speaker apparatus according to claim 3, further comprising a current measurement means electrically coupled with the speaker unit and having an output, said output is indicative of the current through the speaker unit; and a third feedback means to negatively feeding back the output from the current measurement means to the amplifying means.

4. A bass reproduction speaker apparatus, comprising:
a cabinet having an opening and a division member inside thereof, the division member forming a closed space inside the cabinet;
a speaker unit having a diaphragm, said speaker unit disposed at the division member of the cabinet;
an amplifying means for driving the speaker unit;
a bass enhancing member that enhances bass range sound waves, said bass enhancing member is disposed at the opening of the cabinet;
a vibration detection means, included in the bass enhancing member, for detecting vibration of the bass enhancing member and for releasing detecting signals;
a feedback means for negatively feeding back the detecting signals to the amplifying means;
an equalization means receives system input and has an output coupled to the input of said amplifer means, said equalization means exhibiting a high-pass characteristic; and
when the system input bypasses the equalization means and couple to the said amplifier input, said speaker apparatus exhibits a negative slope characteristic between the two resonance frequencies in the low frequency range.

5. The bass reproduction speaker apparatus according to claim 4, further comprising a second vibration detecting means, included in the said speaker unit, for detecting vibration of the speaker unit and for releasing second detecting signals; and a second feedback means for negatively feeding back the second detecting signals to the amplifying means.

6. The bass reproduction speaker apparatus according to claim 5, further comprising a current measurement means electrically coupled with the speaker unit and having an output, said output is indicative of the current through the speaker unit; and a third feedback means to negatively feeding back the output from the current measurement means to the amplifying means.

7. A bass reproduction speaker apparatus, comprising:
a cabinet having a division member inside thereof, the dividing member forming two closed spaces, the cabinet having one opening in each of the said closed space;
a speaker unit having a diaphragm, a first voice coil mechanically coupled with the diaphragm, said speaker unit disposed in the dividing member of the cabinet;
an amplifying means for driving the speaker unit;
a first bass enhancing member that enhances bass range sound waves, said bass enhancing member is disposed at the first opening of the cabinet;
a second bass enhancing member that enhances bass range sound waves, said bass enhancing member is disposed at the second opening of the cabinet;
a first vibration detection means, included in the first bass enhancing member, for detecting vibration of the first bass enhancing member and for releasing first detecting signals;
a second vibration detection means, included in the second bass enhancing member, for detecting vibration of the second bass enhancing member and for releasing second detecting signals;
a first feedback means for negatively feeding back the first detecting signals to the amplifying means; and
a second feedback means for negatively feeding back the second detecting signals to the amplifying means.

8. The bass reproduction speaker apparatus according to claim 7, further comprising a third vibration detecting means, included in the said speaker unit, for detecting vibration of the speaker unit and for releasing third detecting signals; and a third feedback means for negatively feeding back the third detecting signals to the amplifying means.

9. The bass reproduction speaker apparatus according to claim 8, further comprising a current measurement means electrically coupled with the speaker unit and having an output, said output is indicative of the current through the speaker unit; and a forth feedback means to negatively feeding back the output from the current measurement means to the amplifying means.
